(19) United States
(12) Patent Application Publication
(10) Pub. No.: US 2021/0093021 A1
(43) Pub. Date: Apr. 1, 2021

(54) SUPPORTIVE GARMENTS

(71) Applicant: BB Bra Corp., Los Angeles, CA (US)

(72) Inventors: Katherine Rose Barnwell, Los Angeles, CA (US); Yasmina El Maliki Khan, Los Angeles, CA (US)

(21) Appl. No.: 16/588,875

(22) Filed: Sep. 30, 2019

(51) Int. Cl. A41C 3/10

(52) U.S. Cl. CPC A41C 3/10

(57) ABSTRACT

A garment for supporting a breast load of a wearer is described. The garment includes a ribcage enclosure for encircling a ribcage of the wearer. The ribcage enclosure has a length, a width, a lower edge, an upper edge, a first end, a second end, and a thickness, and further includes a breast sheath integral with the ribcage enclosure and sharing the upper edge. The breast sheath is sized and shaped to receive the wearer's breast and the breast sheath includes an engineered bracing integrally formed therein. The engineered bracing conforms to the ribcage of the wearer in a horizontal direction and conforms to an underside of a breast of the wearer in a vertical direction. The garment may be formed by additive manufacturing technology.

### FIELD

The present disclosure relates to supportive garments and in particular, garments for supporting the breast(s) of the wearer.

### BACKGROUND

Brassieres and other similar garments for supporting and shaping the breast(s) of the wearer fail in various ways. Brassieres and other similar garments frustrate and disappoint wearers because they do not fit the wearer. Brassiere manufactures have developed well in excess of 200 standardized brassiere sizes, yet many wearers complain of ill-fitting garments or don the wrong size garment. The fit problem is compounded by the fact that breasts of many wearers are different. Differences exist between wearers' breasts and differences exist between the breasts of individual wearers. Each individual breast is a complex set of three dimensional curves including the curves of the inframammary fold, the curves of the ribcage, the curves of the breast tissue under the breast, the curves of the side of the breast, and the individual wearer's fat stores in and around the breast and ribcage area. Many wearers have one breast that is larger than the other. These factors contribute to ill-fitting brassieres.

The fit problem is further compounded by the fact that average breast sizes are increasing. Whether a result of obesity, hormone imbalances, or of breast implants, the average size of breasts have increased at least one brassiere size in the past 20 years. It is estimated that a pair of D-cup sized breasts weigh between 15 and 20 pounds. The larger the breasts are, the more the breasts move and the greater discomfort the wearer feels when the breasts are in motion. In addition to breast size, breast motion is further impacted by the breast density and the breast weight (also referred to herein as the breast load, where the breast load is the mass or weight to be supported by the garment.)

These factors further contribute to ill-fitting breast support garments, cup gaping, and insufficient support. Insufficient support causes pain and increases breast sagging. Without proper support, women with larger breasts will move (e.g., exercise) less, thus further increasing breast size via weight gain. Current solutions either lack sufficient breast load support or address a three dimensional load support problem with a two dimensional underwire solution.

A new paradigm of support garment is needed. That is, support approached as a physics problem to be solved for every breast individually. Support that both supports and enfolds each breast individually of a wearer, transfers breast load to the wearer's ribcage, and controls breast motion.

### SUMMARY

The present disclosure describes implementations of a garment for supporting a breast load of a wearer. The garment may support the breast load from below the breast in a balanced manner via redistributing breast load to the ribcage. The garment may further encapsulate the wearer's breasts to comfortably support the breast and distribute the breast load through the garment to the ribcage of the wearer. The garment may further decouple breast motion from ribcage motion and dampen breast motion relative to the ribcage to assist in breast motion control

In some implementations, the garment may include three dimensional support structures which conform to the ribcage of the wearer in a horizontal direction and conform to an underside of a breast of the wearer in a vertical direction. In some implementations, the three dimensional support structures of the garment are individually constructed so as to conform to the wearers' unique and individual breasts. In some implementations, the three dimensional support structures are individually constructed so as to transfer the breast load of the wearer to the wearer's ribcage via the garment.

In some implementations, the garment for supporting a breast load of a wearer is integrally formed. In some implementations, the garment for supporting a breast load of a wearer may be unitary (e.g., entirely constructed or formed from the same material in one piece). In some implementations, the garment may be formed via additive manufacturing technologies. In some implementations, the garment may be integrally formed via additive manufacture of a nylon linked fabric. In some implementations, the nylon linked fabric may be a chainmail fabric.

In some implementations, the garment may include motion control mechanisms for controlling breast motion. In some implementations, the garment further includes shock absorbing elastic disposed within the chainmail to dampen the chainmail motion. In some implementations, the elastic may be disposed below, between, or aside the wearer's breasts.

### BRIEF DESCRIPTION OF THE DRAWINGS

FIG. 1 shows a perspective view illustrating an implementation of a garment in accordance with some aspects of the present disclosure.

FIGS. 2A and 2B illustrate cross sectional views of implementations of a garment in accordance with some aspects of the present disclosure.

FIG. 3 shows a perspective view illustrating an implementation of a garment in accordance with some aspects of the present disclosure.

FIG. 4 illustrates a rear perspective view of an implementation of a garment in accordance with some aspects of the present disclosure.

FIG. 5 illustrates a close partial cross-sectional view of one implementation of a closure mechanisms in accordance with some aspects of the present disclosure.

FIG. 6 illustrates a perspective view of one implementation of a garment formed via additive technologies in accordance with some aspects of the present disclosure.

FIG. 7 illustrates a perspective view of one implementation of a garment as shown in FIG. 6.

FIG. 8 illustrates a cross section view of one implementation of a garment formed via additive technologies.

FIG. 9 illustrates a section perspective view of one implementation of a shock absorber formed within a section of a garment in accordance with some aspects of the present disclosure.

FIG. 10 illustrates another implementation of a garment in accordance with some aspects of the present disclosure.

### DETAILED DESCRIPTION

The present disclosure describes various implementations of a garment supporting a breast load. The garment includes a ribcage enclosure for encircling a ribcage. In some implementations, the ribcage enclosure has a length, a width, a lower edge, an upper edge, a first end, a second end, and a thickness. In some implementations, the ribcage enclosure further includes a breast sheath integral with the ribcage enclosure. The breast sheath is sized and shaped to receive the wearer's breast and the breast sheath includes a bracing integrally formed therein. The bracing conforms to the ribcage in a horizontal direction and conforms to an underside of the breast in a vertical direction. In some implementations, a closure may be disposed within the thickness of the first end and the second end for an abutting connection of the first end and the second end. Implementations may include one or more of the following features. In some implementations, the ribcage enclosure includes a second breast sheath integral with the ribcage enclosure. In some implementations, at least a portion of the ribcage enclosure includes a chainmail structure. In some implementations, the ribcage enclosure includes a chainmail structure that is fabricated via additive manufacturing. In some implementations, the garment further includes elastic disposed within chainmail to dampen chainmail motion. In some implementations, the elastic may be disposed below the breast sheath. In some implementations, the elastic may be disposed alongside the breast sheath. In some implementations, the garment further includes a second breast sheath and the elastic may be disposed between the breast sheath and the second breast sheath. In some implementations, at least a portion of the breast sheath is fabricated chainmail. In some implementations, a portion of the breast sheath may be a fabricated solid material. In some implementations, the fabricated solid material includes the bracing. In some implementations, the bracing varies in thickness. In some implementations, the bracing is sized dependent upon the breast load. In some implementations, the garment where the bracing is disposed within the breast sheath is dependent upon the breast load. In some implementations, the closure may include magnetic material disposed within the thickness of the first end and the second end. In some implementations, the closure includes a plurality of ball inserts and alternating socket receptors integrally formed along at least one of the first end or the second end. In some implementations, the garment supporting a breast load of a wearer is fabricated as one piece via additive manufacturing.

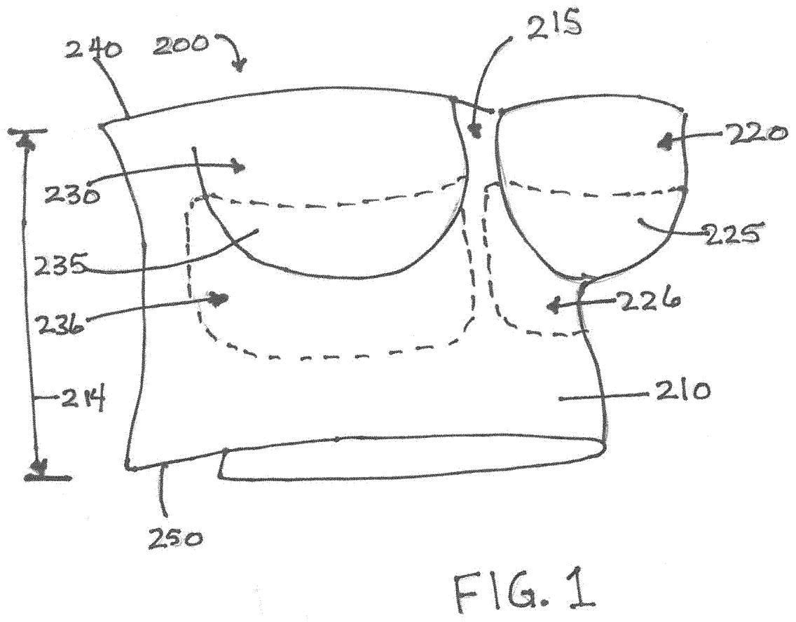

FIG. 1 shows a perspective view illustrating an implementation of a garment in accordance with some aspects of the present disclosure. FIG. 1 shows an implementation of garment 200 for supporting the breast load of a wearer as viewed from a front angled perspective. As illustrated, garment 200 includes ribcage enclosure 210 which, in some implementations, may fully encircle the ribcage of the wearer. Ribcage enclosure 210 includes various areas and components that are more fully described hereinbelow. In some implementations, ribcage enclosure 210 is tightly fitted to the wearer's ribcage and torso and formed of a material possessing sufficient elasticity to comfortably accommodate a wearer's motion and breathing. As described more fully hereinbelow, ribcage enclosure 210 further distributes breast load (e.g., the mass or weight to be supported by the garment) around the wearer's ribcage so as to support the wearer's breasts without the use of shoulder straps. However, it should be appreciated that although garment 200 and, more particularly, ribcage enclosure 210 are described herein as not having shoulder straps (e.g., a “strapless” support garment), in some implementations shoulder strap(s), neck strap(s), or other suitable additional support structure(s) are optional and are not precluded by the disclosure.

Ribcage enclosure 210 includes an upper edge 240. In some implementations, upper edge 240 of ribcage enclosure 210 generally extends horizontally across the wearer's breasts along a lower décolleté area of the wearer's frontal torso (e.g., the upper part of a wearer's frontal torso). In some implementations, upper edge 240 of ribcage enclosure 210 may continue generally horizontally to fully encircle the wearer's ribcage by extending under the wearer's arms and across the wearer's posterior and generally along an upper edge of the wearer's Latissimus dorsi muscles (e.g., the broad upper posterior portion of the torso, traversing the shoulder blades).

Ribcage enclosure 210 further includes a lower edge 250, as illustrated in FIG. 1. Lower edge 250 of ribcage enclosure 210 generally extends horizontally across a lower ribcage area of the wearer's frontal torso and fully encircles the wearer's ribcage. In some implementations, the location of lower edge 250 of ribcage enclosure 210 may be horizontally disposed just under the wearer's inframammary fold (e.g., the natural boundary of a breast from below; where the breast and chest meet). In some implementations, the location of the lower edge 250 of ribcage enclosure 210 may be horizontally disposed lower along the wearer's torso and closer to the wearer's waist. In some implementations, lower edge 250 of ribcage enclosure 210 may continue and extend under the wearer's arms and across the wearer's posterior generally along a lower area of the wearer's Latissimus dorsi muscles (e.g., from below the ribcage to near a wearer's natural waist).

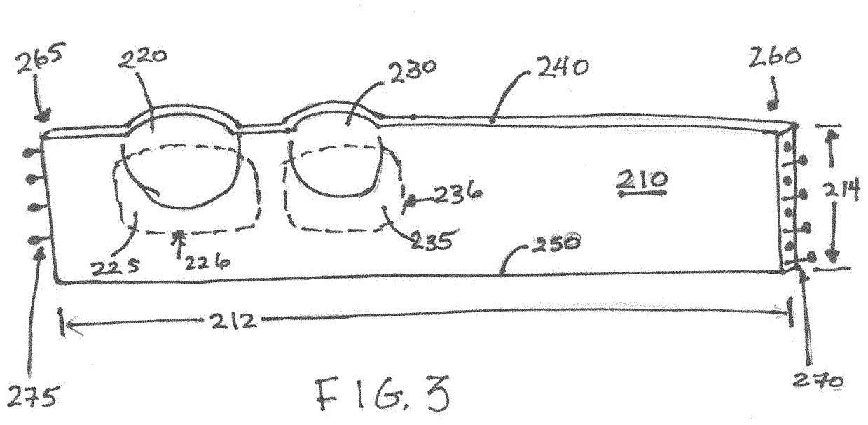

It should be appreciated that the fit location of upper edge 240 of ribcage enclosure 210 and lower edge 250 of ribcage enclosure 210 along the torso of the wearer may be dependent upon a width 214 of ribcage enclosure 210. In some implementations, width 214 of ribcage enclosure 210 may be substantially constant along a length 212, as illustrated in FIG. 3 and discussed more fully hereinbelow. That is, in some implementations, ribcage enclosure 210 may have substantially the same distance between upper edge 240 and lower edge 250. However, it should be appreciated that in other implementations, width 214 may vary along length 212. In some implementations, one or both of upper edge 240 and lower edge 250 may be curved, scalloped, or otherwise suitably or decoratively shaped. In some implementations, width 214 may narrow, taper, slope, or reduce in one or more areas. For example, width 214 may narrow in one or more areas such as between the wearer's breasts in breastbone area 215, under the wearer's arms, or across a user's posterior torso.

Continuing with FIG. 1, garment 200 further includes breast sheath 220 and second breast sheath 230. Breast sheaths 220 and 230 are curved, shaped and formed to at least partially volumetrically encapsulate the breasts of the wearer. In some implementations, breast sheaths 220 and 230 may also act to support and shape the wearer's breast in any suitable manner.

In some implementations, breast sheath 220 includes engineered bracing 225. As used herein, the term engineered bracing means a deliberately arranged support structure. In some implementations, the engineered bracings described herein may be a rigid material. In some implementations, the engineered bracings described herein may be a semi-rigid or not inflexible material. In some implementations, the engineered bracings may be a solid structure. In other implementations. the engineered bracings may be a porous structure (e.g., cellular, honeycombed, open, holey, spongy, chain, linked, or other partially open designed structure).

Similarly, breast sheath 230 includes engineered bracing 235. In some implementations, engineered bracings 225 and 235 may be disposed along a lower curvature of breast sheaths 220 and 230. In some implementations, engineered bracings 225 and 235 may be integrally formed within a lower curvature of breast sheaths 220 and 230. In some implementations, engineered bracings 225 and 235 may be unitarily formed within a lower curvature of breast sheaths 220 and 230. In some implementations, engineered bracings 225 and 235 may extend cantilevered from a wearer's ribcage area along the inframammary fold outward and upward along a vertical curve to at least about a midpoint of the wearer's breasts. In some implementations, the amount that engineered bracings 225 and 235 cantilever outward and upward from the wearer's ribcage may vary based on the size and weight of the breasts being supported. For example, engineered bracings 225 and 235 may cantilever outward and upward from the wearer's ribcage minimally (e.g., up to one inch, measured along the outward and upward curve) when supporting smaller sized breasts. In other implementations, engineered bracings 225 and 235 may cantilever outward and upward from the wearer's ribcage up to as much as six or more inches (measured along the outward and upward curve) when supporting larger sized breasts. It should be appreciated that breast sheaths 220 and 230, and engineered bracings 225 and 235 may be sized as appropriate for the individual breast being supported. It should further be appreciated that that breast sheaths 220 and 230, and engineered bracings 225 and 235 may be disposed as appropriate for the individual breast being supported. That is, in some implementations, breast sheath 220 and engineered bracing 225 may be appropriately sized and disposed for a left breast and breast sheath 230 and engineered bracing 235 may be appropriately sized and disposed for a right breast, where the left breast and the right breast may be unequally shaped and/or differently sized. In this manner, a customized fit may be achieved for each unique wearer and each unique breast.

Further, engineered bracings 225 and 235 may, in some implementations, follow the vertical curvature of the underside of the wearer's breast in both a horizontal direction and in a vertical direction. That is, in addition to engineered bracings 225 and 235 extending cantilevered from a wearer's ribcage area along the inframammary fold outward and upward along a vertical curve to at least a midpoint of the wearer's breasts, engineered bracings 225 and 235 may also extend cantilevered from a wearer's ribcage along the side inframammary fold horizontally outward across the wearer's respective left and right breasts. In this manner, engineered bracings 225 and 235 form three dimensional support structures which enfold and support the wearer's lower breast curve beginning along the wearer's side breast (e.g., the side breast tissue under a wearer's arm where the breast tissue and ribcage meet) and continuing beneath the breast and following the inframammary fold to a central breastbone area 215 located between the wearer's breasts, as indicated in FIG. 1.

As seen in FIG. 1, engineered bracings 225 and 235 additionally extend in a vertical direction downward from a wearer's inframammary fold and along a first ribcage area indicated as 226 and a second ribcage area indicated as 236. In this manner, engineered bracings 225 and 235 extend downward and along the wearer's ribcage in a manner to support the wearer's breast load and to facilitate weight transfer and distribution of breast load over the ribcage. Although illustrated as two separate engineered bracings 225 and 235, it should be appreciated that engineered bracings 225 and 235 could be formed as a unitary bracing joined across central breastbone area 215.

In some implementations, the amount that engineered bracings 225 and 235 extend downward and along the wearer's ribcage areas 226 and 236 may vary based on the breast load of the breasts being supported. For example, engineered bracings 225 and 235 may extend downward and along the wearer's ribcage minimally (e.g., up to one inch, measured radially outward and vertically downward along the inframammary fold curve) when supporting smaller sized breasts. In other implementations, engineered bracings 225 and 235 may extend downward and along the wearer's ribcage as much as four or more inches (measured radially outward and vertically downward along the inframammary fold curve) when supporting larger sized breasts. It should be appreciated that breast sheaths 220 and 230, and engineered bracings 225 and 235 including ribcage bracing areas 226 and 236 may be sized as appropriate for the individual breast being supported. That is, in some implementations, breast sheath 220 and engineered bracing 225 including ribcage bracing area 226 may be sized appropriately for a left breast and breast sheath 230 and engineered bracing 235 including ribcage bracing area 236 may be appropriately sized for a right breast, where the left breast and the right breast may be unequally shaped and/or differently sized. In this manner, a customized fit may be achieved for each unique breast.

In addition to curving in a manner to form three dimensional support structures which enfold and support the wearer's lower breast curve as described above, engineered bracings 225 and 235 are curved in a horizontal direction to engage with and follow the curvature of the wearer's ribcage. That is, the upper part of engineered bracings 225 and 235 are curved, shaped and formed to provide a cantilevered outward and upward support bracing for the lower curve of the wearer's breasts and the lower part of engineered bracings 225 and 235 including ribcage bracing areas 226 and 236 are curved, shaped, and formed to distribute breast load downwardly and horizontally along to the wearer's ribcage. In this manner, as can be appreciated, breast sheaths 220 and 230 including engineered bracings 225 and 235 cooperate to form a three dimensional support structure having curvatures in both a vertical direction and in a horizontal direction unique to each individual wearer's breasts.

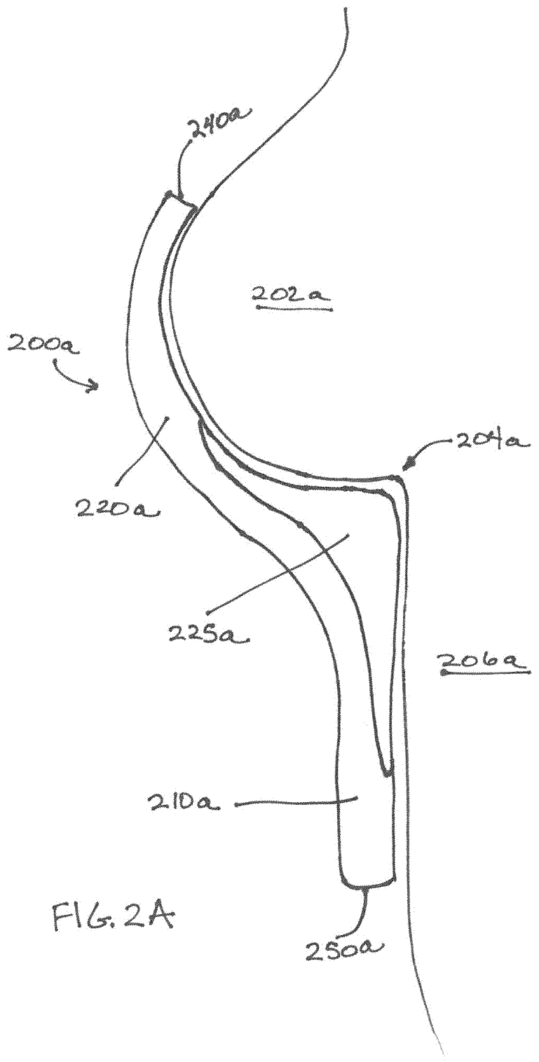

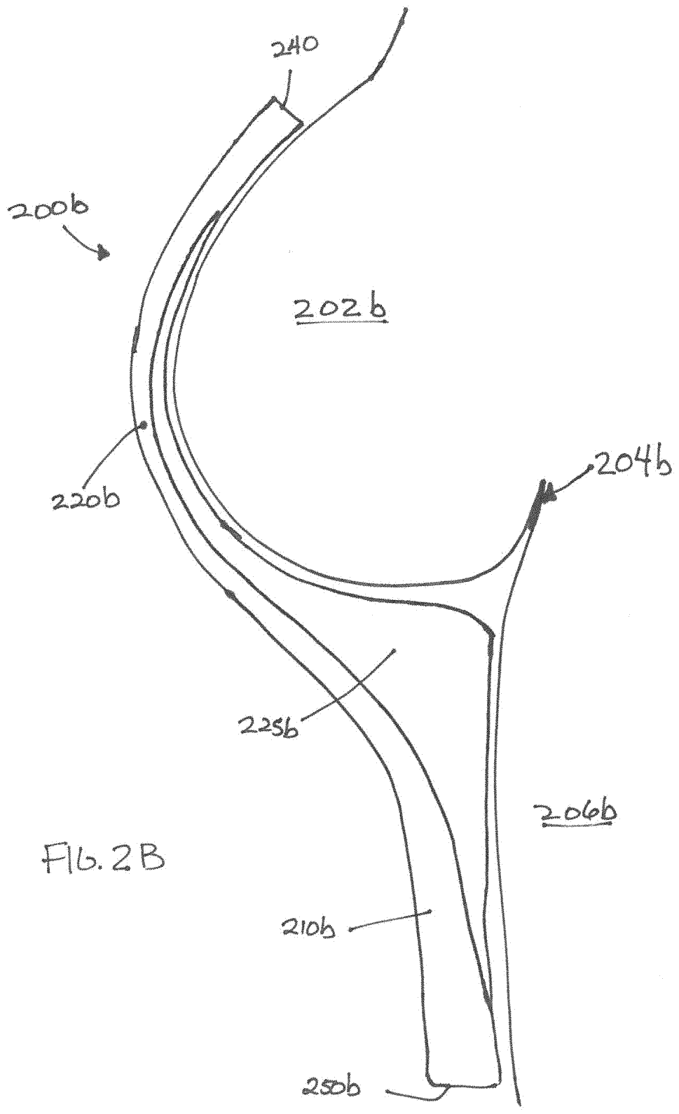

FIGS. 2A and 2B illustrate cross sectional views of some implementations of the garment. FIG. 2A illustrates garment 200a donned by a wearer having a small breast 202a. FIG. 2B illustrates garment 200b donned by a wearer having a large breast 202b. Garment 200a of FIG. 2A illustrates ribcage enclosure 210a, upper edge 240a, lower edge 250a, breast 202a, inframammary fold 204a, ribcage 206a, breast sheath 220a and engineered bracing 225a. Engineered bracing 225a, in one implementation, may vary in thickness along a line perpendicular to vertical when viewed in cross section, to accommodate appropriate support and shaping for the load of breast 202a. That is, engineered bracing 225a may be thicker at a vertical midpoint (e.g., under breast 202a and near inframammary fold 204a) and may be thinner at endpoints in the direction of upper edge 240a and 250a. Because breast 202a is small, engineered bracing 225a may, in some implementations, fit snuggly against the lower curve of breast 202a and connect with inframammary fold 204a. Further, because breast 202a is small, engineered bracing 225a may cantilever outward and upward from the wearer's ribcage minimally (as compared to the garment illustrated in FIG. 2B) and may extend downward and along the wearer's ribcage minimally (as compared to the garment illustrated in FIG. 2B).

FIG. 2B illustrates garment 200a donned by a wearer having a large breast 202b. Garment 200b of FIG. 2B illustrates ribcage enclosure 210b, upper edge 240b, lower edge 250b, breast 202b, inframammary fold 204b, ribcage 206b, breast sheath 220b and engineered bracing 225b. Engineered bracing 225b, in one implementation, may vary in thickness along a line perpendicular to vertical when viewed in cross section, to accommodate appropriate support and shaping for the load of breast 202b. That is, engineered bracing 225b may be thicker at a vertical midpoint (e.g., under breast 202b and near inframammary fold 204b) and may be thinner at endpoints in the direction of upper edge 240b and 250b. Because breast 202b is large, engineered bracing 225b may, in some implementations, fit snuggly against the lower curve of breast 202b and may not connect with inframammary fold 204b as this may be more comfortable and preferable for a large breasted wearer. However, in other implementations, engineering bracing 225b may fit snuggly against the lower curve of breast 202b and in communication with the inframammary fold 204b as this may be more comfortable and preferable for a large breasted wearer. Further, because breast 202b is large, engineered bracing 225b may cantilever outward and upward from the wearer's ribcage to a great extent (as compared to engineered bracing 225a of the garment 200a illustrated in FIG. 2A) and may extend downward and along the wearer's ribcage to a great extent (as compared to the garment 200a illustrated in FIG. 2A).

As can be appreciated, garment 200 and component parts ribcage enclosure 210 including length 212 and width 214, breast sheaths 220, 230, and engineered supports 225, 235 may, in some implementations, be personalized for each wearer. In some implementations, garment 200 may be sized and personally constructed for each individual wearer from measurements derived from the wearer's individual body size, breast size, breast shape, and breast load (e.g., mass). Further, in some implementations, garment 200 sizing and construction may accommodate for a wearer's preferences in style, fit, shaping (e.g., lift, cleavage reveal, or other desired aesthetic presentation), or intended breast support need (e.g., breast support need may vary dependent upon wearer activity such as for formal wear, business wear, casual wear, sportswear, and the like). In other implementations, garment 200 may be sized and constructed in accordance with standard breast support sizing conventions.

FIG. 3 illustrates a perspective view of garment 200 for supporting the breast load of a wearer as viewed from the inside of the garment when the garment is removed from the wearer's body. In FIG. 3, garment 200 and ribcage enclosure 210 exhibit a generally rectangular shape having a length 212 and a width 214 as described above. Also illustrated in FIG. 3 are breast sheaths 220 and 230 including engineered bracings 225 and 235 as described above. Ribcage enclosure 210 includes upper edge 240, lower edge 250 as described above and further includes, in some implementations, first end 260 and a second end 265. In some implementations, first end 260 and second end 265 are abutted in use via closure mechanisms 270 and 275 described hereinbelow. In some implementations, first end 260 and closure mechanism 270 cooperate with second end 265 and closure mechanism 275 to allow for the donning and removal of garment 200 from the body of the wearer. In the implementation shown in FIG. 3, first end 260 is disposed at a greater distance from breastbone area 215 than second end 265 is disposed. As illustrated, a wearer may don garment 200 by aligning breasts with breast sheaths 220 and 230 and wrapping rib cage enclosure under the wearer's right arm, across the wearer's posterior, and securing closure mechanism 270 of first end 260 to closure mechanism 275 of second end 265 under the wearer's left arm. In some implementations, first end 260 is disposed at a lesser distance from breastbone area 215 than second end 265 is disposed so that closure mechanism 270 of first end 260 may be secured to closure mechanism 275 of second end 265 under the wearer's right arm. Yet in some other implementations, first end 260, second end 270, and closure mechanisms 265 and 275 may be dispose in central breastbone area 215, thereby providing for a front closure mechanism for donning and removing garment 200. It should be appreciated that closure mechanisms 265 and 275 may be located at any suitable location along ribcage enclosure 210 that facilitates ease of donning and removing garment 200.

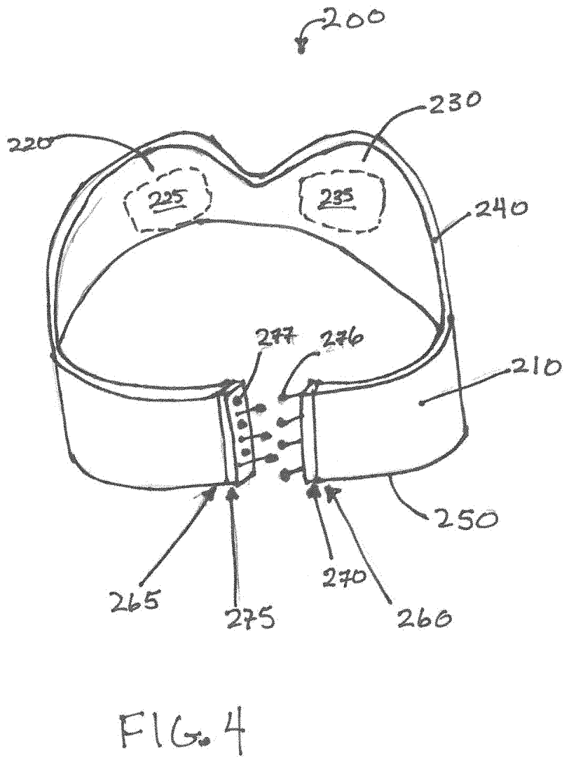

FIG. 4 illustrates a posterior closure implementation for donning and removing garment 200 from a wearer's body. Illustrated in FIG. 4 are breast sheaths 220 and 230 including engineered bracings 225 and 235 as described above. Ribcage enclosure 210 includes upper edge 240, lower edge 250 as described above and further includes, in some implementations, first end 260 and a second end 265. In some implementations, first end 260 and second end 265 are abutted in use via closure mechanisms 270 and 275 described hereinbelow. In some implementations, garment 200 includes a first end 260 and a second end 270 that may be disposed equidistant from breastbone area 215 so as to secure closure mechanism 270 of first end 260 to closure mechanism 275 of second end 265 at a midpoint of the wearer's posterior torso (e.g., at the approximate center of the wearer's posterior).

FIG. 4 illustrates one implementation of closure mechanisms 270 and 275 in greater detail. Each of closure mechanisms 270 and 275 may include alternating and cooperating male closure elements 276 and female closure elements 277. In one implementation, cooperating male closure elements 276 and female closure elements 277 may comprise ball in socket connectors, where male closure element 276 (e.g., a “ball”) is inserted into female closure element 277 (e.g., a socket) thereby creating a friction fit connection and securing first end 260 in an abutting relationship with second end 270. In some implementations, the ball and socket connection formed by cooperating male closure elements 276 and female closure elements 277 may be further strengthened and enhanced by the addition of magnetic materials directly within the construction material or by the addition of magnets disposed within the ball structure and within the socket structure to further facilitate closure. Other suitable male and female closure elements can be used.

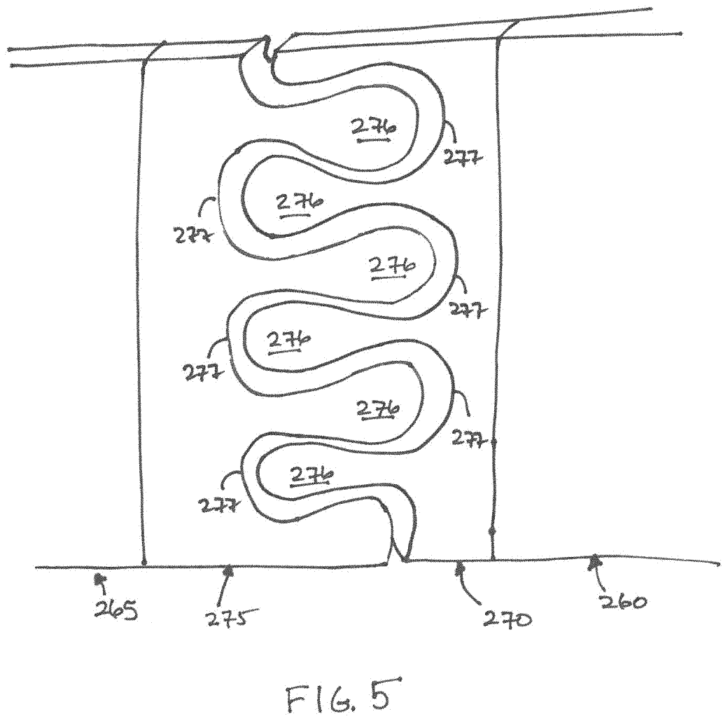

FIG. 5 illustrates a close partial cross-sectional view of closure mechanisms 270 and 275 including one implementation of the alternating and cooperating male closure elements 276 and female closure elements 277. It should be appreciated that, in other implementations, any suitable closure mechanisms (e.g., snap fit structures, zippers, hooks and eyes, magnets, clasps, buckles, tab inserts, toggles, ball joints, anchor shackles, button clasps, and the like) creating a secure abutted or overlapped closure may be utilized.

In some implementations, garment 200 may be integrally formed of a fabric printed via additive manufacturing technologies. In some implementations, the integrally formed fabric printed via additive technologies may be formed from interlocking parts such as, for example, a chainmail structure, as more fully described hereinbelow with respect to FIG. 6. However, it should be appreciated that in other implementations, garment 200 may be formed by any suitable integrally formed fabric (e.g., printed knits) and are not limited to fabrics formed from interlocking parts. It should also be appreciated that in some implementations, the garment 200 may be unitary (e.g., entirely constructed or formed from the same material in one piece).

In some implementations, garment 200 components including ribcage enclosure 210, breast sheaths 220 and 230, engineered bracings 225 and 235, and closure mechanisms 270 and 275 are integrally formed via additive manufacturing (e.g., three dimensional printing or 3D printing). For example, in some implementations, garment 200 may be constructed via HP Multi Jet Fusion™ (“MJF”) printing available from Hewlett Packard. MJF printing is additive manufacturing technology that is fast and allows for voxel-level printing. As used herein, a voxel is a volumetric pixel and the smallest building block of three dimensional additive manufacturing. MJF printing utilizes additive material in the form of powder. The MJF printing powder is deposited in a thin layer by high speed print heads. MJF printing heads then selectively deposit bonding agent(s) and selectively deposit detailing agent(s), both of which are activated by heat from infrared light. The MJF bonding agent causes the powder particles to fuse together to form the voxels of the print geometry for the layer under print. The MJF detailing agent imparts qualities such as color, hardness, elasticity, and the like to the voxels of the print geometry for the layer under print. MJF printing layer thickness may be as thin as 80 microns. Thus, MFJ printing can additively manufacture finely detailed articles having a variety of colors and properties at a voxel by voxel level.

In some implementations, garment 200 may be integrally formed of a fabric printed via additive manufacturing technologies from nylon powders. Nylon is well suited for applications in additive manufacture technologies and, in particular for the fabric of garment 200, nylon is an extremely durable, strong, and low friction material having high fatigue resistance. Nylon is also highly biocompatible and suitable for wear in close connection with the human body. It should be appreciated that in some implementations, materials other than nylons may be utilized for the production of garment 200. Any suitable material or combination of materials are embraced herein. For example, garment 200 may be formed from suitable plastics such as polyolefins, polyurethanes, and polyesters including thermosetting polyesters.

Further, it should be appreciated that garment 200 may be integrally formed via additive manufacture techniques other than MJF. In one implementation, garment 200 may be constructed via fused deposition modeling (“FDM”) printing (e.g., FDM printing utilizing a heated nozzle, a build platform, and a thermoplastic filament to build an object). In other implementations, garment 200 may be constructed via selective laser sintering (“SLS”) printing (e.g., SLS printing utilizing selective laser scanning across particle powders as a platform bed lowers thereby building sintered layers to form an object). It should be appreciated that in some implementations, garment 200 may be formed through other technologies such as molding technologies including injection molding and vacuum forming techniques using suitable materials. It should be appreciated that in some further implementations, garment 200 may be formed, constructed, punched, pieced, cut-out, or otherwise manufactured in non-integral parts which may be stitched or otherwise suitably attached to form garment 200 as described hereinabove.

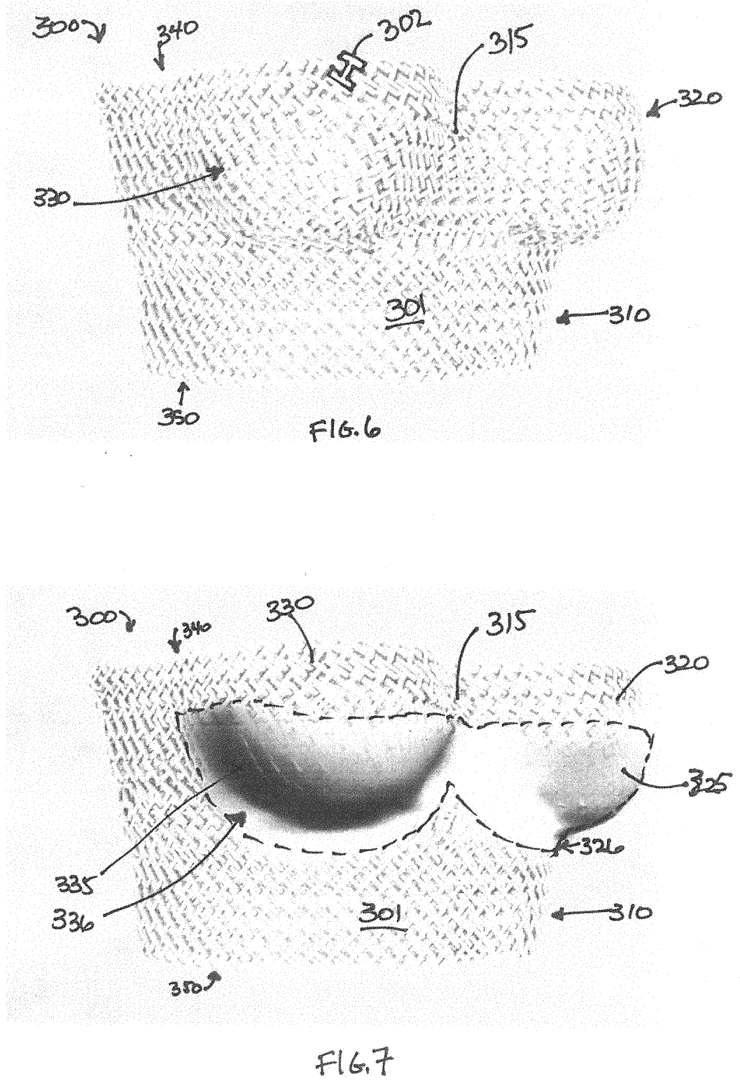

FIGS. 6-9 illustrate aspects and perspective views of one implementation of garment 300 formed from an integrally formed fabric printed via additive technologies. In particular, garment 300 of FIGS. 6 and 7 generally correspond in structure to garment 200 of FIG. 1 and illustrate and implementation of garment 300 formed via additive manufacture from interlocking parts referred to herein as a chainmail fabric or “chainmail.”

The chainmail fabric 301 illustrated in FIG. 6 is comprised of interlocking three dimensional “H” like structures 302. The three dimensional “H” structure 302 is formed of two perpendicular disposed “H”s that are distanced. That is, a first “H” structure includes distanced rearward connection lengths connecting the two upper endpoints and the two lower endpoints of the “H” letter's side vertical lengths. These rearward connecting lengths, in turn, form the vertical side structures of a second “H” structure disposed perpendicularly angled and rearwardly from the first “H” structure. Each loop interlocks with, in some implementations, a loop from another identical “H” structure perpendicularly angled to the first “H” structure. In this manner an individual three dimensional “H” structure 302 is formed. In some implementations, a plurality of three dimensional “H” structures 302 are interlinked to form a flexible, articulatable, and strong fabric having a smooth upper and lower surfaces where the fabric thickness is the thickness of the “H” structure include the reward connecting lengths.

It should be appreciated that the chainmail fabric 301 illustrated in FIGS. 6-9 is merely for illustration of some implementations of an interlocking fabric or chainmail achievable via additive manufacturing technology and is not limiting to the principles and concepts disclosed herein. Any one of a variety of interlocking part or chainmail patterns are suitable for construction of the garment disclosed herein and contemplated garment construction.

As shown in FIGS. 6 and 7, garment 300 includes ribcage enclosure 310 which, in some implementations, may fully encircle the ribcage of the wearer. Ribcage enclosure 310 generally corresponds to ribcage enclosure 210 described above with respect to FIG. 1 and for certain parts, descriptions may not be fully repeated for brevity. Ribcage enclosure 310 distributes breast load weight around the wearer's ribcage so as to support the wearer's breasts without the use of shoulder straps. However, it should be appreciated that although garment 300 and, more particularly, ribcage enclosure 310 are described herein as not having shoulder straps (e.g., a “strapless” support garment), in some implementations shoulder strap(s), neck strap(s), or other suitable additional supportive or engineered support structure(s) are optional and are not precluded by the disclosure.

Ribcage enclosure 310 includes an upper edge 340. In some implementations, upper edge 340 of ribcage enclosure 310 generally extends horizontally across the wearer's breasts along a lower décolleté area of the wearer's frontal torso (e.g., the upper part of a wearer's frontal torso). In some implementations, upper edge 340 of ribcage enclosure 310 may continue generally horizontally to fully encircle the wearer's ribcage by extending under the wearer's arms and across the wearer's posterior and generally along an upper edge of the wearer's Latissimus dorsi muscles (e.g., the broad upper posterior portion of the torso, traversing the shoulder blades).

Ribcage enclosure 310 further includes a lower edge 350, as illustrated in FIG. 7. Lower edge 350 of ribcage enclosure 310 generally extends horizontally across a lower ribcage area of the wearer's frontal torso and fully encircles the wearer's ribcage. In some implementations, the location of lower edge 350 of ribcage enclosure 310 may be horizontally disposed just under the wearer's inframammary fold (e.g., the natural boundary of a breast from below; where the breast and chest meet). In some implementations, the location of the lower edge 350 of ribcage enclosure 310 may be horizontally disposed lower along the wearer's torso and closer to the wearer's waist. In some implementations, lower edge 350 of ribcage enclosure 310 may continue and extend under the wearer's arms and across the wearer's posterior generally along a lower area of the wearer's Latissimus dorsi muscles (e.g., from below the ribcage to near a wearer's natural waist).

It should be appreciated that the fit location of upper edge 340 of ribcage enclosure 310 and lower edge 350 of ribcage enclosure 310 along the torso of the wearer may be dependent upon a width 314 of ribcage enclosure 310. In some implementations, width 314 of ribcage enclosure 310 may be substantially constant along a length 312, as previously illustrated and discussed. In some implementations, width 314 of ribcage enclosure 310 may be variable along a length 312.

Continuing with FIG. 7, garment 300 further includes breast sheath 320 and second breast sheath 330. Breast sheaths 320 and 330 are curved, shaped and formed to at least partially volumetrically encapsulate the breasts of the wearer. In some implementations, breast sheaths 320 and 330 may also act to support and shape the wearer's breast in any suitable manner.

In some implementations, breast sheath 320 includes engineered bracing 325. Similarly, breast sheath 330 includes engineered bracing 335. In some implementations, engineered bracings 325 and 335 may be disposed along a lower curvature of breast sheaths 320 and 330, as indicated by solid areas in FIG. 7, shown for location illustration. It should be appreciated that bracings 325 and 335, in some implementations, may be solid material formed on the inside of garment 300 so as to contact the ribcage and breasts of the wearer.

In some implementations, engineered bracings 325 and 335 may be integrally formed with a lower curvature of breast sheaths 320 and 330. In some implementations, engineered bracings 325 and 335 may extend cantilevered from a wearer's ribcage area along the inframammary fold outward and upward along a vertical curve to at least about a midpoint of the wearer's breasts. In some implementations, the amount that engineered bracings 325 and 335 cantilever outward and upward from the wearer's ribcage may vary based on the size and weight of the breasts being supported. For example, engineered bracings 325 and 335 may cantilever outward and upward from the wearer's ribcage minimally (e.g., up to one inch, measured along the outward and upward curve) when supporting smaller sized breasts. In other implementations, engineered bracings 325 and 335 may cantilever outward and upward from the wearer's ribcage up to as much as six or more inches (measured along the outward and upward curve) when supporting larger sized breasts. It should be appreciated that breast sheaths 320 and 330, and engineered bracings 325 and 335 may be sized as appropriate for the individual breast being supported. It should further be appreciated that that breast sheaths 320 and 330, and engineered bracings 325 and 335 may be disposed as appropriate for the individual breast being supported. That is, in some implementations, breast sheath 320 and engineered bracing 325 may be appropriately sized and disposed for a left breast and breast sheath 330 and engineered bracing 335 may be appropriately sized and disposed for a right breast, where the left breast and the right breast may be unequally shaped and/or differently sized. In this manner, a customized fit having curvatures in both a vertical direction and in a horizontal direction may be achieved for each unique wearer and each unique breast.

Further, engineered bracings 325 and 335 may, in some implementations, follow the vertical curvature of the underside of the wearer's breast in both a horizontal direction and in a vertical direction. That is, in addition to engineered bracings 325 and 335 extending cantilevered from a wearer's ribcage area along the inframammary fold outward and upward along a vertical curve to at least a midpoint of the wearer's breasts, engineered bracings 325 and 335 may also extend cantilevered from a wearer's ribcage along the side inframammary fold horizontally outward across the wearer's respective left and right breasts. In this manner, engineered bracings 325 and 335 form three dimensional support structures which enfold and support the wearer's lower breast curve beginning along the wearer's side breast (e.g., the side breast tissue under a wearer's arm where the breast tissue and ribcage meet) and continuing beneath the breast and following the inframammary fold to a central breastbone area 315 located between the wearer's breasts, as indicated in FIG. 7.

As seen in FIG. 7, engineered bracings 325 and 335 additionally extend in a vertical direction downward from a wearer's inframammary fold and along a first ribcage bracing area indicated as 326 and a second ribcage bracing area indicated as 336. In this manner, engineered bracings 325 and 335 extend downward and along the wearer's ribcage in a manner to support the wearer's breast load and to facilitate weight transfer and distribution of breast load over the ribcage. Although illustrated as two separate engineered bracings 325 and 335, it should be appreciated that engineered bracings 325 and 335 could be formed as a unitary bracing joined across central breastbone area 315.

In some implementations, the amount that engineered bracings 325 and 335 extend downward and along the wearer's ribcage bracing areas 326 and 336 may vary based on the size and weight of the breasts being supported. For example, engineered bracings 325 and 335 may extend downward and along the wearer's ribcage minimally (e.g., up to one inch, measured radially outward and vertically downward along the inframammary fold curve) when supporting smaller sized breasts. In other implementations, engineered bracings 325 and 335 may extend downward and along the wearer's ribcage as much as four or more inches (measured radially outward and vertically downward along the inframammary fold curve) when supporting larger sized breasts. It should be appreciated that breast sheaths 320 and 330, and engineered bracings 325 and 335 including ribcage bracing areas 326 and 336 may be sized as appropriate for the individual breast being supported. That is, in some implementations, breast sheath 320 and engineered bracing 325 including ribcage bracing area 326 may be sized appropriately for a left breast and breast sheath 330 and engineered bracing 335 including ribcage bracing area 336 may be appropriately sized for a right breast, where the left breast and the right breast may be unequally shaped and/or differently sized. In this manner, a customized fit may be achieved for each unique breast.

In addition to curving in a manner to form three dimensional support structures which enfold and support the wearer's lower breast curve as described above, engineered bracings 325 and 335 are curved in a horizontal direction to engage with and follow the curvature of the wearer's ribcage. That is, the upper part of engineered bracings 325 and 335 are curved, shaped and formed to provide a cantilevered outward and upward support bracing for the lower curve of the wearer's breasts and the lower part of engineered bracings 325 and 335 including ribcage bracing areas 326 and 336, are curved, shaped, and formed to distribute breast load downwardly and along to the wearer's ribcage. In this manner, as can be appreciated, breast sheaths 320 and 330 including engineered bracings 325 and 335 cooperate to form a three dimensional support structure unique to each individual wearer's breasts.

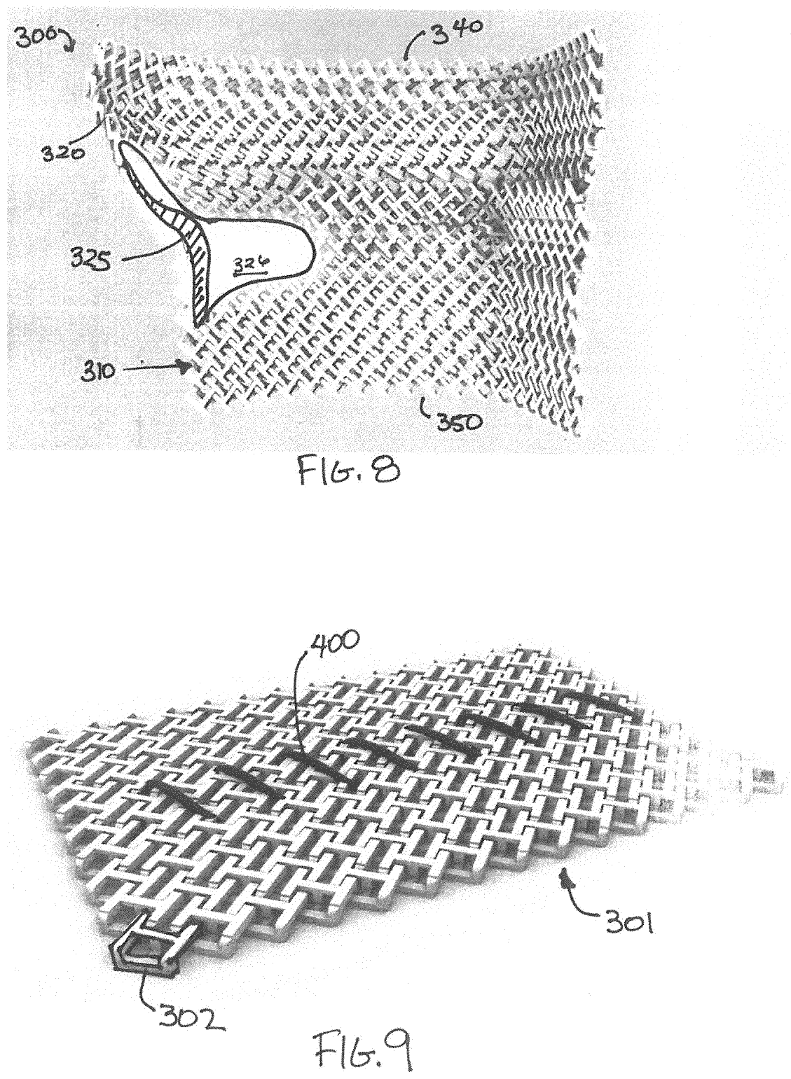

FIG. 8 illustrates a cross section perspective view of one implementation of garment 300 formed from an integrally formed fabric printed via additive technologies. FIG. 8 is similar to FIG. 2B. FIG. 8, however, omits the wearer's body structures. Garment 300 of FIG. 8 illustrates ribcage enclosure 310, upper edge 340, lower edge 350, breast sheath 320 and engineered bracing 325. Engineered bracing 325, in one implementation, may vary in thickness along a line perpendicular to vertical when viewed in cross section, to accommodate appropriate support and shaping for the load of breast 202b. That is, engineered bracing 325 may be thicker at a vertical midpoint and may be thinner at endpoints in the direction of upper edge 340 and 350 as described above with respect to garment 200b illustrated in FIG. 2B. As can be appreciated from FIG. 8, engineered bracing 325 is curved and shaped to in a vertical direction to provide a cantilevered outward and upward support bracing for the lower curve of the wearer's breast, and ribcage bracing area 326 is curved in a horizontal direction along the wearer's ribcage.

FIG. 9 illustrates a section perspective view of one implementation of a shock absorber formed within a section of a garment in accordance with aspects of the present disclosure. FIG. 9 additionally shows a close up view of the illustrative chainmail fabric 301 comprised of three dimensional “H” structures 302 discussed hereinabove with respect to FIG. 6. As noted hereinabove, the nature of chainmail fabric 301 (as interconnected linked parts) is such that individual three dimensional “H” structures 302 may move relative to one another. That is, chainmail fabric 301 may flex or move due to the nature of chainmail construction in addition to any intrinsic flexibility of the nylon or other material utilized in fabric manufacture. As such, it may be desirable, in some implementations, to include or fabricate movement limiting mechanisms in desired locations of garment 300 so as to selectively reduce, limit, or dampen chainmail fabric link motion. In some implementations, shock absorber 400 as illustrated in FIG. 9 may be embedded into the chainmail fabric 301 of garment 300 during additive manufacturing. In some implementations, shock absorber 400 may be inserted into the chainmail fabric 301 after manufacture. As illustrated, shock absorber 400 may have a generally spiral shape and be selectively threaded through three dimensional “H” structures 302 or around selective links of three dimensional “H” structures 302. In some implementations, shock absorber 400 may be comprised of voxels of material having different elastomeric qualities than voxels of three dimensional “H” structures 302. For example, where three dimensional “H” structures 302 may be fabricated of nylon voxels, shock absorber 400 may be fabricated of thermoplastic elastomers or other rubber-like materials. In some implementations, shock absorber 400 may tightly limit motions is specific areas or directions of fabric 301. Yet in some implementations, shock absorber may allow motions of fabric 301 but may serve to isolate such motions and rapidly dampen such motions.

Shock absorber 400 may be of any desired length and may be disposed in any desired location of garment 300. For example, in some implementations, it may be desirable to control motion of breast sheaths 320 and 330 in a vertical direction. Accordingly, one or more shock absorbers 400 may be disposed along the sides of breast sheaths 320 and 330 as well as in between breast sheaths 320 and 330 in central breastbone area 315. In some implementations, it may be desirable to control motion of breast sheaths 320 and 330 in a horizontal direction and accordingly one or more shock absorbers 400 may be disposed along the ribcage near the inframammary fold region. In some implementations, shock absorbers 400 may be disposed at other desired locations along the length and width of ribcage enclosure 310 so as to increase the comfort and wearability of garment 300.

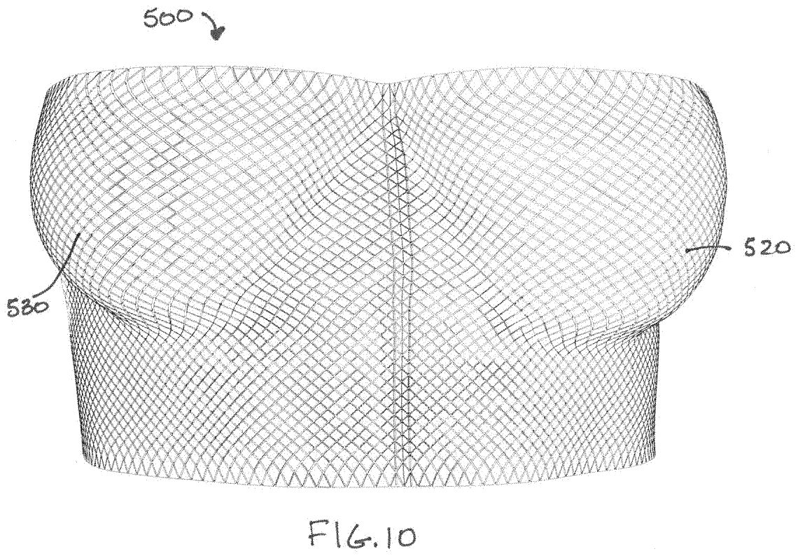

Turning to FIG. 10, a decorative variation of a chainmail garment based on the principles described herein is illustrated. Garment 500 of FIG. 10 is illustrative of a variation of chainmail fabric 301 described hereinabove with respect to FIGS. 6-9. Garment 500 includes all components parts as described herein with respect to garment 200 of FIGS. 1-5 and garment 300 of FIGS. 6-9. However, garment 400 illustrates an aesthetic variation of chainmail fabric construction discussed hereinabove.

As apparent from the garment 500 of FIG. 10, the wearer's leftmost breast is slightly larger than the wearer's right breast and garment 500 has been constructed with a breast sheath 520 that is slightly larger than breast sheath 530. However, it is within the scope of the disclosure that the engineered support of a smaller breast may be sized, shaped, and thickened in a manner so as to balance and equate breasts of unequal size and shape. Further, it is within the scope of the disclosure that an entire matched breast sheath may be printed integral to garment 500 for post-mastectomy wearers lacking one or more breasts.

The supportive garments described herein may further be incorporated into broader fashionable outerwear. In some implementations, the principles of a supportive garment as describe herein may form a base garment for larger garments manufactured via additive technologies. The supportive garments described herein may, in some implementations, include full necklines, sleeves, halters, tops, dresses, swimwear, and the like. In some other implementations, the supportive garments herein may be covered with, or incorporated into, more traditional fabric garment designs as a “built in” support feature.

The advantages of the supportive garments described herein are numerous. In some implementations, the features described herein technologically improves the garment by creating customized and comfortable breast load distribution throughout the garment and a transfer of breast load to the wearer's ribcage. The use of additive manufacturing technology allows for the creation of garments of custom size for individual wearers and for individual breasts in a manner heretofore unknown. Further, the inclusion of embedded shock absorber material allows for a disassociation of and a decoupling of breast motion from ribcage motion in a manner heretofore unknown.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A garment supporting a breast load comprising:
a ribcage enclosure for encircling a ribcage, the ribcage enclosure having a length, a width, a lower edge, an upper edge, a first end, a second end, and a thickness;
the ribcage enclosure further comprising a breast sheath integral with the ribcage enclosure, wherein the breast sheath is sized and shaped to receive the wearer's breast, wherein the breast sheath further comprises a bracing integrally formed therein, wherein the bracing conforms to the ribcage in a horizontal direction and conforms to an underside of a breast in a vertical direction; and
a closure disposed within the thickness of the first end and the second end for an abutting connection of the first end and second end.

2. The garment of claim 1, wherein the ribcage enclosure comprises a second breast sheath integral with the ribcage enclosure.

3. The garment of claim 1, wherein at least a portion of the ribcage enclosure comprises a chainmail structure.

4. The garment of claim 3, wherein the ribcage enclosure comprises a chainmail structure that is fabricated via additive manufacturing.

5. The garment of claim 1, wherein at least a portion of the breast sheath comprises a chainmail structure.

6. The garment of claim 1, wherein at least a portion of the breast sheath comprises a solid material.

7. The garment of claim 6, wherein the solid material comprises the bracing.

8. The garment of claim 7, wherein the bracing varies in thickness.

9. The garment of claim 6, wherein the bracing is sized dependent upon the breast load.

10. The garment of claim 6, wherein the bracing is disposed within the breast sheath dependent upon the breast load.

11. The garment of claim 3, further comprising elastic disposed within the chainmail structure to dampen motion of the chainmail structure.

12. The garment of claim 11, wherein the elastic is disposed below the breast sheath.

13. The garment of claim 11, wherein the elastic is disposed alongside the breast sheath.

14. The garment of claim 11, further comprising a second breast sheath and the elastic is disposed between the breast sheath and the second breast sheath.

15. The garment of claim 1, wherein the closure comprises magnetic material disposed within the thickness of the first end and the second end.

16. The garment of claim 1, wherein the closure comprises a plurality of ball inserts and alternating socket receptors integrally formed along at least one of the first end or the second end.

17. The garment of claim 1, wherein the garment is fabricated as one piece via additive manufacturing.
